(19) United States
(12) Patent Application Publication
(10) Pub. No.: US 2025/0261043 A1
(43) Pub. Date: Aug. 14, 2025

(54) CREATING AND MANAGING VIRTUAL ACCESS POINTS FOR A PLURALITY OF MULTIPLE BASIC SERVICE SET IDENTIFIER GROUPS

(71) Applicant: HEWLETT PACKARD ENTERPRISE DEVELOPMENT LP, Spring, TX (US)

(72) Inventors: Jinzhao Ren, Beijing (CN); Xuguang Jia, Beijing (CN); Xiaoyang Fu, Beijing (CN); Chunfeng Wang, Beijing (CN)

(21) Appl. No.: 18/438,622

(22) Filed: Feb. 12, 2024

(51) Int. Cl. H04W 28/18; H04L 5/00; H04W 28/06; H04W 72/0446; H04W 72/121

(52) U.S. Cl. CPC H04W 28/18; H04L 5/0048; H04W 28/06; H04W 72/0446; H04W 72/121

(57) ABSTRACT

Examples described herein relate to a method for creating and managing a plurality of Multiple Basic Service Set Identifier (MBSSID) groups. The method may include configuring the MBSSID groups by setting a Maximum BSSID indicator to a value such that each of the plurality of MBSSID groups is allowed to utilize VAP slots up to a VAP capacity of the AP so long as the VAP capacity of the AP is not fully exhausted. Accordingly, when a request to create a VAP in a given MBSSID group is received, and the VAP capacity of the AP is not fully exhausted, the AP may create the VAP at any available VAP slot. The VAP is created such that a BSSID of the VAP is determined based on the Maximum BSSID indicator and a BSSID index relative to a transmit VAP of the given MBSSID group.

### BACKGROUND

With the advancements in wireless networking technologies, wireless networking devices such as Access Points (APs) allow the creation of Virtual Access Points (VAPs). Each of these VAPs is configured with a unique Basic Service Set Identifier (BSSID) and appears as an individual AP to client devices. In some implementations, to improve airtime efficiency, support for a Multiple Basic Service Set Identifier (MBSSID) is suggested in 802.11ax Specification by the Institute of Electrical and Electronics Engineers (IEEE) (hereinafter referred to as IEEE 802.11ax Specification). An MBSSID represents a collection of all the VAPs configured on the AP in which one of the VAPs is configured as a transmitting VAP or transmitted VAP and the rest of the VAPs are configured as non-transmitting VAPs or non-transmitted VAPs. As per the IEEE 802.11ax Specification, an AP configured with the MBSSID can send a common beacon for the MBSSID instead of sending individual beacons for each VAP.

In certain instances, to avoid beacon size bloating, an AP may be configured to form multiple MBSSID groups each comprising one transmitted VAP and one or more non-transmitted VAPs. This allows the AP to send individual separate smaller size beacons for each such MBSSID group compared to the single large beacon for the MBSSID that groups all VAPs. However, forming multiple MBSSID groups limits the number of VAP slots in each MBSSID group.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts a block diagram of a wireless networking device in which various of the examples presented herein may be implemented.

FIG. 2 depicts a flowchart of an example method for creating Multiple Basic Service Set Identifier (MBSSID) groups and a virtual access point (VAP) in one or more of the MBSSID groups.

FIG. 3 depicts a flowchart of another example method for creating MBSSID groups and a VAP in one or more of the MBSSID groups.

FIG. 4 depicts a flowchart of yet another example method for managing non-transmitted VAPs of an MBSSID group when a transmitted VAP of the MBSSID group becomes inoperative.

FIG. 5 depicts a block diagram of an example computing system.

FIGS. 6-8 depict various tables illustrating example VAP configurations.

The Figures are not exhaustive and do not limit the present disclosure to the precise form disclosed.

### DETAILED DESCRIPTION

Advances in wireless networking technologies drive technological improvements in other technologies and industries. For example, various industries rely on wireless networking technologies for the communication, storage, and delivery of data and services. In wireless networks, client devices wirelessly connect to a network through an AP. Increasing usage of wireless networking technologies, among other factors, creates various technological challenges in the field of wireless networking. The Institute of Electrical and Electronics Engineers (IEEE) has issued various standard Specifications, such as the 802.11 Specifications to address various challenges in the field of wireless networking technologies. For instance, as various technologies increasingly rely on wireless networking technologies, there becomes a need to expand the capabilities of wireless networks to accommodate larger numbers of devices with varying configurations. For example, configuring the virtual access points (VAPs) on an access point (AP) allows the AP to present itself as multiple APs. To client devices, a VAP appears as a separate AP. A VAP can be configured with respective network properties, such as authentication and encryption, and is identified via a unique Basic Service Set Identifier (BSSID). Thus, each VAP can be associated with a BSSID configured with a set of network properties associated with the VAP.

Typically, an AP announces a wireless network by transmitting a beacon frame. In the case of an AP configured with multiple VAPs, the AP typically broadcasts a beacon frame for each VAP of the multiple VAPs, where the beacon frame includes a BSSID associated with the VAP. The beacon frames are broadcast to the client devices. The client devices use the BSSID included in the beacon frames to determine a VAP to connect. In some deployments, an AP can support multiple wireless networks using multiple VAPs. In these deployments, broadcasting a separate beacon frame for each VAP (i.e., for each BSSID) may be inefficient and degrade the connection quality of the wireless networks.

A technique to address the inefficiencies and network degradation associated with broadcasting separate beacon frames entails implementing a Multiple Basic Service Set Identifier (MBSSID) in accordance with IEEE 802.11ax Specification. An MBSSID is a group of VAPs hosted on an AP for which the AP can make use of common management frames, such as beacons and probes, for example. A beacon frame corresponding to the MBSSID is hereinafter referred to as an MBSSID beacon. In the MBSSID beacon, a BSSID field is set to a BSSID of one of the VAPs of the MBSSID. The VAP whose BSSID is used in the BSSID field in the MBSSID beacon is referred to as a transmitted VAP and its BSSID is referred to as a transmitted BSSID. The rest of the VAPs of the MBSSID are referred to as non-transmitted VAPs and their BSSIDs are referred to as non-transmitted BSSIDs. Broadcasting the MBSSID beacons allows the AP to use fewer beacon frames than the AP would by broadcasting separate beacon frames individually for each VAP.

While the use of the MBSSID allows APs to broadcast information associated with a plurality of VAPs forming the MBSSID with improved airtime efficiency, the use of the MBSSID faces various technological challenges. For example, advertising all the VAPs in a single MBSSID beacon may lead to beacon size bloating (i.e., the MBSSID beacon size becoming too large). The IEEE 802.11ax Specification suggests Enhanced MBSSID Advertisement (EMA) features to deal with the overflowing beacon contents. However, the EMA features are not mandated by the Wi-Fi Alliance tests and hence not widely deployed. To address this issue, APs may be configured to support the use of multiple MBSSID groups which entails dividing VAPs into multiple groups. The AP then sends a beacon for each of such MBSSID groups. For example, if the VAPs hosted on the AP are grouped into a plurality of MBSSID groups, instead of sending one large beacon for all of the VAPs hosted on the AP, the AP may send a beacon for each of the plurality of MBSSID groups.

It is apparent that as the number of MBSSID groups increases for a fixed VAP capacity (i.e., a maximum number of VAPs that can be configured on an AP) on an AP, the number of VAPs in each MBSSID group reduces. For example, if the VAP capacity of an AP is 16 (i.e., a maximum of 16 VAPs can be configured on the AP) and the AP is configured with four MBSSID groups, each MBSSID group can have a maximum of four VAP slots. Accordingly, the AP can fulfill a request to configure a new VAP in a given MBSSID if the given MBSSID group has an available VAP slot. However, if the given MBSSID group has no empty VAP slot, the AP cannot fulfill a request to configure a new VAP in the given MBSSID group despite one or more available VAP slots in other MBSSID groups. In the description, the terms “available slot” and “empty slot” have been used interchangeably. This in turn wastes available VAP slots and the VAP capacity of the AP may not be fully utilized.

In a traditional implementation, when an AP is configured to operate with four MBSSID groups having group identifiers—MBSSID 1, MBSSID 2, MBSSID 3, and MBSSID 4, each MBSSID group is restricted to have a maximum of 4 VAP slots. In particular, out of the total VAP capacity with 16 VAP slots (e.g., VAP slots 1 through 16) available on the AP, VAP slots 1 through 4 may be allocated to MBSSID 1, VAP slots 5-8 may be allocated to MBSSID 2, VAP slots 9-12 may be allocated to MBSSID 3, and VAP slots 13-16 may be allocated to MBSSID 4. During the operation of the AP, it may be possible that one or more of the MBSSID groups may not have any empty slots while other MBSSID groups may have empty slots. For instance, the MBSSID 3 may have no VAP slot left for new VAP deployments, whereas MBSSID 1, MBSSID 2, and MBSSID 4 have available VAP slots. In such a configuration, if the AP receives a request to configure a new VAP in MBSSID 3, the AP cannot fulfill such a request because MBSSID 3 does not have any empty VAP slot.

In addition, if a transmitted VAP in an MBSSID group goes down (e.g., malfunctions, becomes inoperable, or is removed), the non-transmitted VAPs also become non-functional. Accordingly, the client devices associated with the non-transmitted VAPs may disconnect from the respective non-transmitted VAPs and experience network outages until they associate with other VAPs.

To address the aforementioned challenges, in examples consistent with the teachings of this disclosure, a wireless networking device, such as an access point (AP) that intelligently configures a plurality of MBSSID groups is presented. The proposed AP configures the MBSSID groups such that a VAP can be created in a given requested MBSSID group so long as the VAP capacity of the AP is not exhausted. Generally, the maximum count of VAPs in each of the plurality of MBSSID groups (VAP_{GroupMAXcount}) is determined as 2^{MAXBSSID}^{_{Indicator}}, wherein MAXBSSID_{Indicator} represents the Maximum BSSID indicator. As such, the Maximum BSSID indicator dictates the maximum count of VAPs in each MBSSID group. In some known implementations, the value of the Maximum BSSID indicator is selected such that all of the MBSSID groups have an equal number of VAP slots available to accommodate VAPs therein. For instance, for an AP with a VAP capacity of 16, the Maximum BSSID indicator may be set to 2 (e.g., MAXBSSID_{Indicator}=2), which in turn allows each MBSSID group to accommodate 4 VAPs.

In accordance with examples presented herein, the AP configures a plurality of MBSSID groups by setting the Max BSSID indicator to a value such that each of the plurality of MBSSID groups is allowed to utilize VAP slots up to a VAP capacity of the AP. For instance, for the AP having a VAP capacity of 16, the AP may set the Max BSSID indicator to 4, allowing each MBSSID group to accommodate up to 16 VAPs to the extent that the VAP capacity of the AP is not fully exhausted. Accordingly, when a request to create a VAP in a given MBSSID group is received, the AP may perform a check to determine if the VAP capacity of the AP is not fully exhausted (i.e., a count of configured VAPs in the wireless networking device is smaller than the VAP capacity). Upon determining that the VAP capacity of the AP is not fully exhausted, the AP may create the VAP at any available VAP slot. The created VAP may be identified via its BSSID which is determined based on a BSSID index and the Maximum BSSID indicator. The BSSID index of the created VAP is an offset between the transmitted BSSID of the target MBSSID group and the VAP slot at which the VAP is created. Such a creation of the VAP enables the AP to fulfill a VAP creation request in any of the MBSSID groups so long as the AP has empty VAP slots (i.e., the VAP capacity of the AP 100 is not fully exhausted). This way the AP can maximize the utilization of its VAP capacity and cater to an increased number of client devices with varied quality of service requirements.

In some examples, after configuring a plurality of MBSSID groups such that each of the plurality of MBSSID groups is allowed to utilize VAP slots up to a VAP capacity of the AP, the AP may receive a first request to configure a first VAP in a first MBSSID group of the plurality of MBSSID groups. Then, responsive to determining that the VAP capacity of the AP is not fully exhausted, the AP may create the first VAP in the first MBSSID group. The BSSID of the first VAP (a first BSSID index) can be determined based on a maximum count of VAP slots configurable in each of the plurality of MBSSID groups and a first BSSID index relative to a first transmit VAP of the first MBSSID group. Further, in some examples, the AP may receive a second request to configure a second VAP in a second MBSSID group of the plurality of MBSSID groups. After receiving the second request and in response to determining that the VAP capacity of the AP is not fully exhausted, the AP may create the second VAP in the second MBSSID group. The BSSID of the second VAP (a second BSSID index) can be determined based on a maximum count of VAP slots configurable in each of the plurality of MBSSID groups and a second BSSID index relative to a first transmit VAP of the first MBSSID group.

Furthermore, in some examples, the proposed AP is configured to seamlessly manage the non-transmitted VAPs in a given MBSSID group in case its transmitted VAP becomes inoperative avoiding prolonged network outages for client devices associated with the non-transmitted VAPs. This is achieved, at least in part, due to intelligent steering of the non-transmitted VAPs to another MBSSID group. In one example, upon detecting that the transmitted VAP of the given MBSSID becomes inoperative, the AP may steer the non-transmitted VAPs of the given MBSSID group to a target MBSSID group whose beacon size is below a first threshold value and so long as the beacon size remains below a second threshold value. This not only makes the non-transmitted VAP operational but also ensures that the beacon size of the target MBSSID group remains under control.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

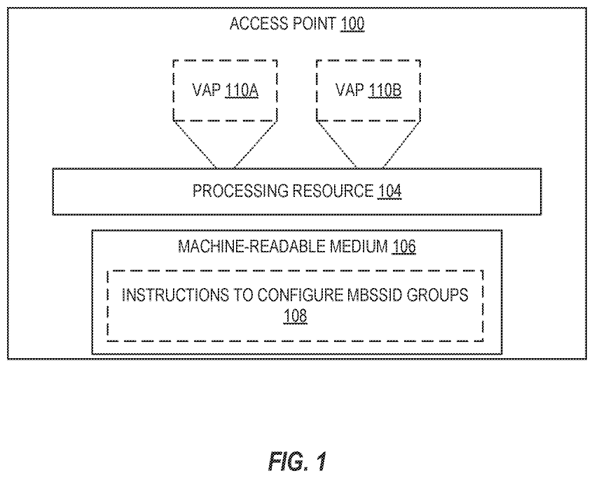

FIG. 1 illustrates a wireless networking device, for example, an access point (AP) 100 in which various of the examples presented herein may be implemented. The AP 100 may be implemented in any setup for example, in a home setup or an organization, such as a business, educational institution, governmental entity, healthcare facility, or other organization. The AP 100 may be a combination of hardware, software, and/or firmware that is configured to provide wireless network connectivity to the client devices (not shown). In some examples, the AP 100 may comprise, be implemented as, or known as a radio router, radio transceiver, a switch, a Wi-Fi hotspot device, Basic Service Set (BSS) device, Extended Service Set (ESS) device, radio base station (RBS), or some other terminology and may act as a point of network access for the client devices 106A-106D. Although not shown, in some examples, the AP 100 may include additional network devices such as, but not limited to, additional APs, wireless local area network (WLAN) controllers, network switches, gateway devices, routers, and the like. Via the AP 100, the client devices may communicate with each other and/or with any other network device to which the AP 100 is communicatively connected (e.g., the network switches, the WLAN controller, and/or gateway devices).

The client devices connecting to the AP 100 may be electronic devices capable of wirelessly communicating with an AP 100 or other electronic devices. Examples of client devices may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, Internet of Things (IoT) devices, and the like. Communications between the AP 100 and the client devices may be facilitated via wireless communication links established according to wireless communication protocols such as the IEEE 802.11 standards, Wi-Fi Alliance Specifications, or any other wireless communication standards. In some examples, the communication between the client devices and the AP 100 may be carried out in compliance with IEEE 802.11ax Specification.

In some examples, the AP 100 may include a processing resource 104 and/or a machine-readable storage medium 106 for the AP 100 to execute several operations as will be described in the greater details below. The machine-readable storage medium 106 may be non-transitory and is alternatively referred to as a non-transitory machine-readable storage medium that does not encompass transitory propagating signals. The machine-readable storage medium 106 may be any electronic, magnetic, optical, or other storage device that may store data and/or executable instructions. Examples of the machine-readable storage medium 106 that may be used in the AP 100 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 106 may be encoded with executable instructions 108 (depicted using a dashed box in FIG. 1) for configuring MBSSID groups for the AP 100 and managing VAPs hosted on the AP 100. Although not shown, in some examples, the machine-readable storage medium 106 may be encoded with certain additional executable instructions to perform any other operations performed by the AP 100, without limiting the scope of the present disclosure.

The processing resource 104 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 106, or combinations thereof. The processing resource 104 may fetch, decode, and execute the instructions 108 stored in the machine-readable storage medium 106 to configure MBSSID groups for the AP 100 and manage VAPs hosted on the AP 100. As an alternative or in addition to executing the instructions 108, the processing resource 104 may include at least one integrated circuit (IC), control logic, electronic circuits, or combinations thereof that include a number of electronic components for performing the functionalities intended to be performed by the AP 100.

Further, as shown in FIG. 1, the AP 100 may be configured with a set of logical entities such as VAPs 110A and 110B (hereinafter collectively referred to as VAPs 110A, 110B) that are depicted using dashed boxes in FIG. 1. In particular, configuration files and program instructions (not shown) to execute the VAPs 110A, 110B are stored in the machine-readable storage medium 106. A configuration file for a given VAP may include settings such as radio details, SSID, channel information, a BSSID, communication capabilities, and the like. Each of the VAPs 110A, 110B is associated with a unique BSSID configured with a set of network properties associated with the VAP. A BSSID of a given VAP may act as a unique address for the given VAP. In one example, the BSSID may be expressed as a unique string of hexadecimal numbers of predefined length. The processing resource 104 may execute program instructions according to the respective configuration files to enable the functioning of the VAPs 110A, 110B.

A VAP (e.g., the VAP 110A or 100B) appears as an independent AP with a wireless network name, commonly referred to as, a service set identifier (SSID). In the example implementation of FIG. 1, the VAPs 110A, 110B configured on the AP 100 may appear as two independent APs advertised via respective SSIDs to the client devices discovering the wireless networks. For illustration purposes, the AP 100 is shown as configured with two VAPs 110A, 110B. In some examples, the AP 100 may be configured with a greater or fewer number of VAPs than depicted in FIG. 1 without limiting the scope of the present disclosure. In certain implementations, the number of VAPs configured on an AP such as the AP 100 may be restricted to a VAP capacity of the AP 100. The VAP capacity may refer to the maximum number of VAPs that can be created on a given AP, for example, the AP 100. Client devices may associate with any of the VAPs 110A, 110B as if they are associating with any physical AP.

In the present implementation of FIG. 1, the AP 100 may be configured to implement a plurality of Multiple Basic Service Set Identifier (MBSSID) groups. An MBSSID is a set of VAPs hosted on an AP (e.g., the AP 100) for which the AP can make use of common management frames, such as beacons and probes, for example. In the present implementation, the AP 100 may transmit a separate beacon frame for each of the plurality of MBSSID groups. In such a beacon, a BSSID field is set to a BSSID of one of the VAPs of the respective MBSSID group. The VAP whose BSSID is used in the BSSID field of the beacon is referred to as a transmitted VAP and its BSSID is referred to as a transmitted BSSID. The rest of the VAPs of the MBSSID group are referred to as non-transmitted VAPs and their BSSIDs are referred to as non-transmitted BSSIDs. Broadcasting such beacons allows the AP to use fewer beacon frames than the AP would by broadcasting separate beacon frames individually for each VAP. Also, instead of sending one large beacon for all of the VAPs hosted on the AP 100, the individual beacon for each MBSSID group would avoid beacon size bloating issues.

To address the challenges associated with implementing multiple MBSSID groups (such as, the non-availability of VAP slots for new VAP creations and issues arising from non-functional TX-VAP described earlier), the proposed AP 100 intelligently configures a plurality of MBSSID groups in examples consistent with the teachings of this disclosure. In particular, the AP 100 configures the MBSSID groups such that a new VAP can be created in a given requested MBSSID group so long as the VAP capacity of the AP 100 is not exhausted. Generally, the maximum count of VAPs in each of the plurality of MBSSID groups (VAP_{GroupMAXcount}) is determined as 2^{MAXBSSID}_{Indicator}, wherein MAXBSSID_{Indicator} represents the Maximum BSSID indicator. As such, the MAXBSSID_{Indicator} dictates the maximum count of VAPs in each MBSSID group.

In accordance with examples presented herein, the AP 100 configures a plurality of MBSSID groups by setting MAXBSSID_{Indicator} to a value that allows each of the plurality of MBSSID groups to utilize any number of VAP slots up to the VAP capacity of the AP. For instance, if the AP 100 has a VAP capacity of 16, the AP 100, the MAXBSSID_{Indicator} may be set to 4 resulting in the value of 2^{MAXBSSID}^{_{Indicator}} being 16, which allows each MBSSID group to accommodate up to 16 VAPs to the extent that the VAP capacity of the AP 100 is not fully exhausted.

When a request to create a VAP in a target MBSSID group is received, the AP 100 may perform a check to determine if the VAP capacity of the AP 100 is not fully exhausted (i.e., a count of configured VAPs in the wireless networking device is smaller than the VAP capacity). Upon determining that the VAP capacity of the AP 100 is not fully exhausted, the AP may create the VAP at any available VAP slot. The created VAP may be identified via its BSSID which is determined based on a BSSID index and the Maximum BSSID indicator. The BSSID index of the created VAP is an offset between the transmitted BSSID of the target MBSSID group and the VAP slot at which the VAP is created. Such a creation of the VAP enables the AP 100 to fulfill a VAP creation request in any of the MBSSID groups so long as the AP 100 has empty VAP slots (i.e., the VAP capacity of the AP 100 is not fully exhausted). This way the AP 100 can maximize the utilization of its VAP capacity and cater to an increased number of client devices with varied quality of service requirements.

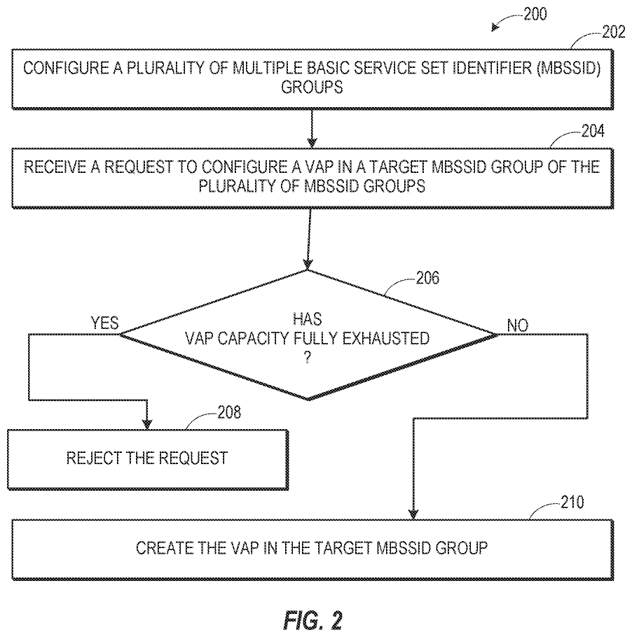

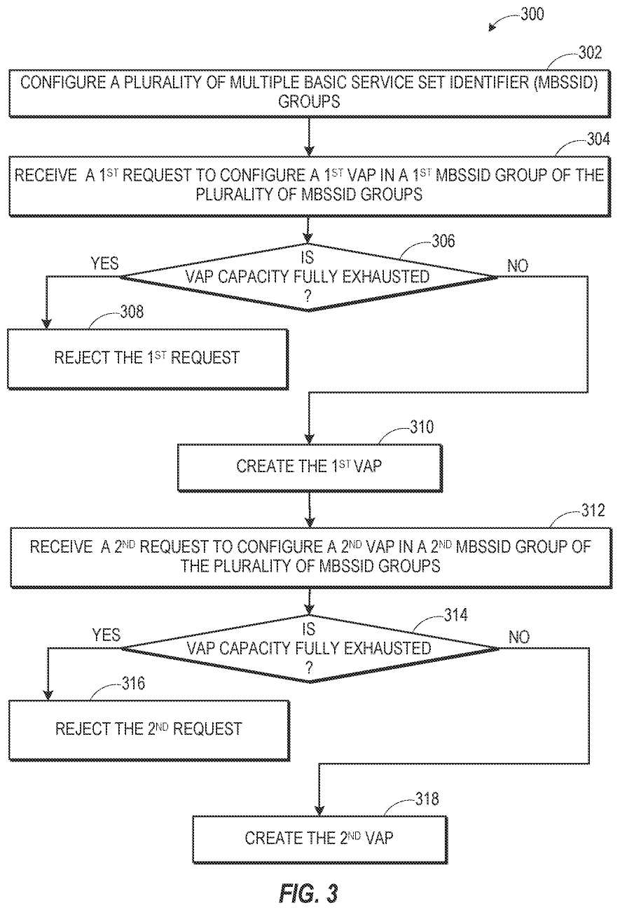

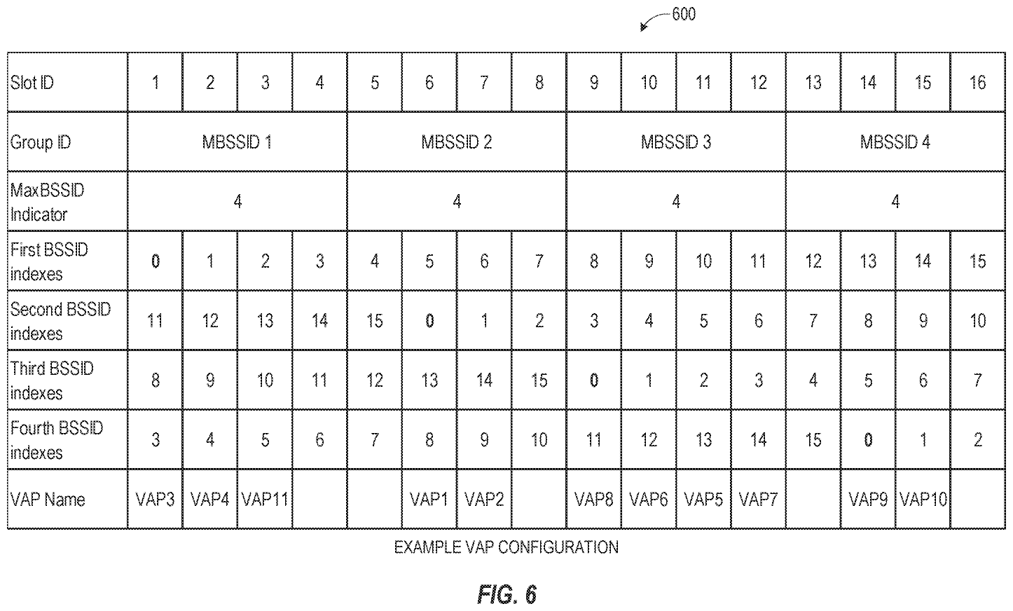

In some examples, after configuring a plurality of MBSSID groups, the AP 100 may receive a first request to configure a first VAP in a first MBSSID group of the plurality of MBSSID groups. Then, responsive to determining that the VAP capacity of the AP 100 is not fully exhausted, the AP 100 may create the first VAP (e.g., the VAP 110A) at a first available VAP slot in the first MBSSID group. The first VAP is identified via a first BSSID that is determined based on the maximum count of VAP slots configurable in each of the plurality of MBSSID groups and a first BSSID index. The first BSSID index is an offset between a first transmitted BSSID of the first MBSSID group and the first available slot. Further, in some examples, the AP 100 may receive a second request to configure a second VAP in a second MBSSID group of the plurality of MBSSID groups. After receiving the second request and in response to determining that the VAP capacity of the AP is not fully exhausted, the AP 100 may create the second VAP (e.g., the VAP 110B) at a second available VAP slot in the second MBSSID group. The second VAP is identified via a second BSSID that is determined based on the maximum count of VAP slots configurable in each of the plurality of MBSSID groups and a second BSSID index. The second BSSID index is an offset between a second transmitted BSSID of the second MBSSID group and the second available slot. Additional details about creating VAPs are described in conjunction with methods described in FIGS. 2 and 3 and tables presented in FIGS. 6-8.

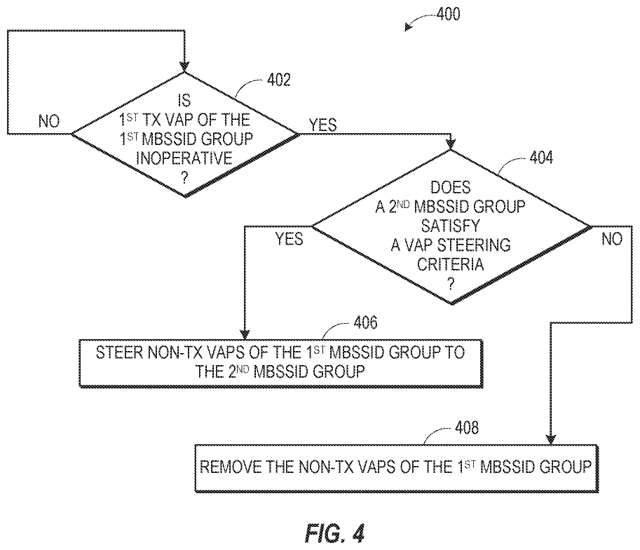

Furthermore, in some examples, the proposed AP 100 is configured to seamlessly manage the non-transmitted VAPs in a given MBSSID group in case its transmitted VAP becomes inoperative, thereby avoiding prolonged network outages for client devices associated with the non-transmitted VAPs. This is achieved, at least in part, due to intelligent steering of the non-transmitted VAPs to another MBSSID group. In one example, upon detecting that the transmitted VAP of the given MBSSID becomes inoperative, the AP 100 may steer the non-transmitted VAPs of the given MBSSID group to another MBSSID group whose beacon size is below a threshold value. This not only makes the non-transmitted VAP operational but also ensures that the beacon size of the target MBSSID group remains under control. Additional details about managing VAPs are described in conjunction with the method described in FIG. 4.

In the description hereinafter, various operations performed by a wireless networking device, for example, the AP 100, are described with the help of flowcharts depicted in FIGS. 2-4. Also, the tables presented in FIGS. 6-8 are referenced during the description of FIGS. 2-4 to aid in the illustration of the methods. FIGS. 2-4 depict flowcharts of example methods for configuring MBSSID groups and creating/managing VAPs in these MBSSID groups. The steps that are shown in FIGS. 2-4 may be performed locally at any suitable device, such as a wireless networking device (e.g., the AP 100 of FIG. 1). In some examples, the suitable device may include a processing resource suitable for retrieval and execution of instructions (e.g., the instructions 108) stored in a machine-readable storage medium. The processing resource and the machine-readable storage medium may be example representatives of the processing resource 104 and the machine-readable storage medium 106 of the AP 100 of FIG. 1. As an alternative or in addition to retrieving and executing instructions, the processing resource may include one or more electronic circuits that include electronic components for performing the functionality of one or more instructions, such as an FPGA, ASIC, or other electronic circuits. Further, the flowcharts that are shown in FIGS. 2-4 include several steps in a particular order. However, the order of steps shown in the respective flowcharts should not be construed as the only order for the steps. The steps may be performed at any time, in any order. Additionally, the steps may be repeated or omitted as needed.

FIG. 2 depicts a method 200 for configuring MBSSID groups and creating a VAP in an MBSSID group. At step 202, the AP configures a plurality of MBSSID groups by setting a Maximum Basic Service Set Identifier indicator (MAXBSSID_{Indicator}) to a value that allows each of the plurality of MBSSID groups to utilize VAP slots up to the VAP capacity of the AP. As per the IEEE standard specifying the support for the MBSSID groups, the maximum count (N) of VAPs in each MBSSID may be determined as 2^{MAXBSSID}^{_{Indicator}}. In an example implementation, if the VAP capacity of the AP is 16, the AP, in examples consistent with the present disclosure, may create a plurality of MBSSID groups where each MBSSID group can use any number of the available VAP slots so long the VAP capacity of the AP is not fully exhausted. In one example, this is achieved by setting the MAXBSSID_{Indicator} based on the VAP capacity (C). Equation 1 represented below represents an example value of the MAXBSSID_{Indicator}.

$${MAXBSSID}_{Indicator} = \frac{Log ( C )}{Log ( 2 )}$$

By way of example, for the AP having the VAP capacity (C) of 16, the MAXBSSID_{Indicator} may be set to

$$\frac{Log ( 16 )}{Log 2 )} = 4 .$$

The value of MAXBSSID_{Indicator} set to 4 allows each of the MBSSID groups created on the AP to virtually reference any number of VAP slots up to the VAP capacity (e.g., 16). For instance, if the number of MBSSID groups created is 4, then each of the four MBSSID groups can virtually reference all VAP slots on the AP, allowing the AP to create VAPs in any of the four MBSSID groups provided the VAP capacity of the AP is not fully exhausted.

Further, at step 204, the AP may receive a request to configure a VAP in a target MBSSID group of the plurality of MBSSID groups. The target MBSSID group for the VAP may be specified in the request. Upon receiving the request, the AP, at step 206, may perform a check to determine if the VAP capacity of the AP is not fully exhausted. In particular, the AP may check if the number of VAPs already configured on the AP is less than the VAP capacity. If it is determined that the number of VAPs already configured on the AP is less than the VAP capacity, the AP may determine that the VAP capacity of the AP is not fully exhausted. Alternatively, if the number of VAPs already configured on the AP is the same as the VAP capacity, the AP is considered to have exhausted all its VAP capacity. At step 206, if it is determined that the VAP capacity of the AP is fully exhausted, the AP, at step 208, may reject the request. In some examples, the AP may display or communicate a message or alert indicating the request cannot be fulfilled as the VAP capacity is exhausted.

However, at step 206, if it is determined that the VAP capacity of the AP is not fully exhausted, the AP at step 210, may create the VAP whose BSSID is determined relative to the transmitted BSSID of the target MBSSID group and the MAXBSSID_{Indicator} set at step 202. The AP may create the VAP at any of the available VAP slots. Each VAP slot may be recognized by a unique BSSID index relative to each transmitted BSSID. The BSSID index for a given VAP slot may be referred to as an offset between a transmitted BSSID and the given VAP slot. In an example, where the MAXBSSID_{Indicator} is set to 4, and the transmitted BSSID of the target MBSSID group is 00:01:02:03:00:fO, the BSSIDᵢ of the VAP created at a BSSID index i may be determined using the following example relationship of Equation 2.

$${BSSID}_{i} = 00 : 01 : 02 : 03 : 00 : [ fO - ( fO \% N ) + ( ( ( fO \% N ) + i ) \% N ) ]$$

where, N=2^{MAXBSSID}^{_{Indicator}}.

By way of example, if the BSSID index i=8, and the MAXBSSID_{Indicator} is set to 4 (i.e., N=16), the BSSID& may be determined as 00:01:02:03:00:f8. This way, the newly created VAP may be part of part of the target MBSSID group so long as the VAP capacity of the AP is not fully exhausted at the time of receiving the request at step 204. FIG. 6 depicts a table 600 illustrating a first example VAP configuration with four MBSSID groups and the MAXBSSID_{Indicator} is set to 4. For ease of illustration, FIG. 6 is described concurrently herein.

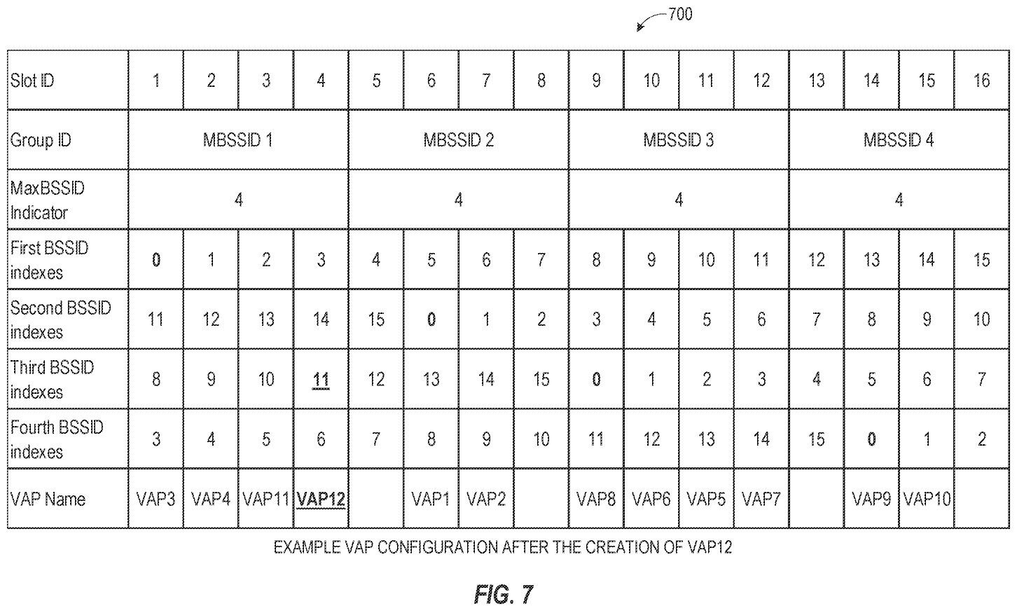

In the example configuration presented in the table 600, the AP has a total of 16 VAP slots represented via the Slot IDs represented in row 1. Further, the AP hosts VAP1-VAP11 on respective MBSSID groups-MBSSID 1, MBSSID 2, MBSSID3, and MBSSID 4 as shown. The VAP3, VAP1, VAP8, and VAP 9 are transmitted VAPs respectively in MBSSID 1, MBSSID 2, MBSSID3, and MBSSID 4. The rest of the VAPs are non-transmitted VAPs. Further, in the table 600, the first BSSID indexes (shown in Row 4 of the table 600) represent offsets for respective slot IDs relative to the transmitted VAP of MBSSID 1 (i.e., VAP3), the second BSSID indexes (shown in Row 5 of the table 600) represent offsets for respective slot IDs relative to the transmitted VAP of MBSSID 2 (i.e., VAP1), the third BSSID indexes (shown in Row 6 of the table 600) represent offsets for respective slot IDs relative to the transmitted VAP of MBSSID 3 (i.e., VAP8), and the fourth BSSID indexes (shown in Row 7 of the table 600) represent offsets for respective slot IDs relative to the transmitted VAP of MBSSID 4 (i.e., VAP9). In this situation, if the AP receives a request to create a new VAP, for example, VAP12, the AP may select any empty VAP slot, for example, the VAP slot with the Slot ID 4, and create VAP12. In particular, FIG. 7 depicts a table 700 illustrating an example VAP configuration after the creation of VAP12 with Slot ID 4. For ease of illustration, FIG. 7 is described concurrently herein.

As depicted in the table 700 of FIG. 7, VAP12 is created at Slot ID 4 which has the BSSID index 11 relative to the transmitted VAP (i.e., VAP8) of the MBSSID 3. Accordingly, VAP12 gets a unique BSSID that can be calculated based on the transmitted BSSID (i.e., BSSID of VAP8) of MBSSID 3. On the contrary, in traditional implementation with MAXBSSID_{Indicator} set to 2, an AP would have rejected the request to create a new VAP in MBSSID 3 as each MBSSID would have only 4 VAP slots available.

Turning now to FIG. 3, a flowchart of another example method 300 for creating VAPs in an MBSSID group is presented. The method 300 of FIG. 3 includes certain steps that are similar to those described in FIG. 2, certain details of which are not repeated herein for the sake of brevity.

At step 302, the AP configures a plurality of MBSSID groups by setting a Maximum Basic Service Set Identifier indicator (MAXBSSID_{Indicator}) to a value that allows each of the plurality of MBSSID groups to utilize VAP slots up to the VAP capacity of the AP. In one example, the AP may set MAXBSSID_{Indicator} to a value such that each MBSSID group can utilize VAP slots up to the VAP capacity of the AP in a similar fashion as described in conjunction with FIG. 2 (see step 202, for example). Further, at step 304, the AP may receive a request to configure a first VAP in a first MBSSID group of the plurality of MBSSID groups that were created at step 302. Upon receiving the first request, the AP, at step 306, may perform a check to determine if the VAP capacity of the AP is not fully exhausted.

At step 306, if it is determined that the VAP capacity of the AP is fully exhausted, the AP, at step 308, may reject the first request. In some examples, the AP may display or communicate a message or alert indicating the first request cannot be fulfilled as the VAP capacity is exhausted. However, at step 306, if it is determined that the VAP capacity of the AP is not fully exhausted, the AP at step 310, may create the first VAP in the first MBSSID group. In particular, the AP may create the first VAP at any of the available VAP slots. The first VAP is identified via a first BSSID that can be determined based on the first transmitted BSSID and the MAXBSSID_{Indicator} set at step 302. The first transmitted BSSID is a BSSID of a transmitted VAP of the first MBSSID group. In an example, where the MAXBSSID_{Indicator} is set to 4 with the VAP capacity being 16, and the first transmitted BSSID is 00:01:02:03:00:fO, the BSSID; of a first VAP created at a BSSID index i may be determined using the example relationship of Equation 2 noted earlier. By way of example, if the BSSID index i=8, the MAXBSSID_{Indicator} is set to 4 (i.e., N=16), and the transmitted BSSID of the first MBSSID group is 00:01:02:03:00:fO, the BSSID₈ may be determined as 00:01:02:03:00:f8. This way, the newly created VAP may be part of part of the first MBSSID group so long as the VAP capacity of the AP was not fully exhausted at the time of receiving the request at step 304.

In one example, as shown in the table 700 (see FIG. 7), a first VAP such as VAP12 may be created in MBSSID 3 (e.g., the first MBSSID group) at an empty VAP slot (with Slot ID 4 with BSSID index 11 with reference to the VAP8 (i.e., the transmitted VAP of the MBSSID 3).

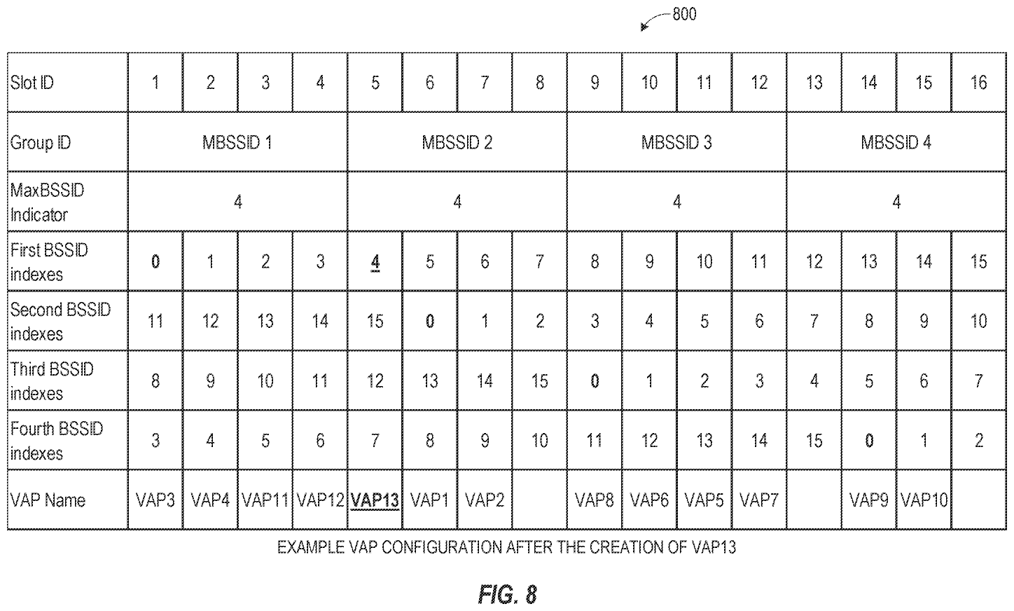

Further, during the operation of the AP, the AP may, at step 312, receive a second request to create a second VAP (e.g., VAP13) in a second MBSSID group (e.g., MBSSID1-see the table 700). Upon receiving the first request, the AP, at step 314, may perform a check to determine if the VAP capacity of the AP is not fully exhausted. At step 314, if it is determined that the VAP capacity of the AP is fully exhausted, the AP, at step 316, may reject the second request. In some examples, the AP may display or communicate a message or alert indicating the second request cannot be fulfilled as the VAP capacity is exhausted. However, at step 314, if it is determined that the VAP capacity of the AP is not fully exhausted, the AP at step 318, may create the second VAP. The AP may create the second VAP at any of the available VAP slots. The second VAP is identified via a second BSSID that can be determined based on the second transmitted BSSID, and the MAXBSSID_{Indicator} set at step 302. The second transmitted BSSID is a BSSID of a transmitted VAP of the second MBSSID group. This way, the newly created VAP may become part of the second MBSSID group so long as the VAP capacity of the AP was not fully exhausted at the time of receiving the second request at step 312. For example, if the AP receives the second request to create the second VAP (e.g., VAP13) in a second MBSSID group (e.g., MBSSID 1), the AP may select any empty VAP slot, for example, the VAP slot with the Slot ID 5, and create VAP13. In particular, FIG. 8 depicts a table 800 illustrating an example VAP configuration after the creation of VAP13 with Slot ID 5. For ease of illustration, FIG. 8 is described concurrently herein.

As depicted in the table 800 of FIG. 8, VAP13 is created at Slot ID 5 which has the BSSID index 4 relative to the second transmitted VAP (i.e., VAP3) of the MBSSID 1. Accordingly, VAP13 gets the second BSSID that can be calculated based on the second transmitted BSSID (i.e., BSSID of VAP3) of a second MBSSID group (e.g., MBSSID 3), the BSSID index (e.g., 4), and the MAXBSSID_{Indicator}. For example, if the second transmitted BSSID is 00:01:02:03:01:fO, using the example relationship of Equation 2 and the BSSID index i=4, the second BSSID (e.g., the BSSID of VAP13) may be determined as 00:01:02:03:01:O4. On the contrary, in traditional implementation with MAXBSSID_{Indicator} set to 2, an AP would have rejected the request to create a new VAP in MBSSID 3 as each MBSSID would have only 4 VAP slots available.

Referring now to FIG. 4, a flowchart of an example method 400 for managing VAPs is presented. The method 400 may be performed by an AP for example the AP 100 of FIG. 1 anytime, periodically, or at random intervals, during execution of any of the methods 200 and 300 described in FIGS. 3 and 4. The terms first MBSSID group and second MBSSID group may refer to any two of a plurality of MBSSID groups created on the AP. Accordingly, a first transmit VAP and a second transmit VAP may refer to the transmit VAPs of the first MBSSID group and the second MBSSID group, respectively.

At step 402, the AP may perform a check to determine if a first transmit VAP is inoperative. The first transmit VAP may be a transmit VAP of a first MBSSID group of the plurality of MBSSID groups formed on the AP. A VAP is said to be inoperative if it is determined that the VAP does not exist anymore, is removed/deleted, or is unable to perform as desired. At step 402, if it is determined that the first transmit VAP is operative, the AP may continue to perform the check at step 402. At step 402, if it is determined that the first transmit VAP is inoperative, the AP, at step 404, may perform a check to determine if the second MBSSID group satisfies a VAP steering criterion. In particular, the VAP steering criterion may include—(a) the second transmit VAP in the second MBSSID group is operative, and (b) a beacon size for the second MBSSID group is smaller than a threshold value. The beacon size may be representative of the length of a beacon frame, represented as the number of bits or bytes in the beacon frame, for example. If the second MBSSID group satisfies the above two conditions, the second MBSSID group is said to have satisfied the VAP steering criterion.

At step 404, if it is determined that the second MBSSID group satisfies the VAP steering criterion, the AP, at step 406, may steer a non-transmitted VAP of the first MBSSID group to the second MBSSID group. In some examples, the AP may perform the check at step 404, to steer any additional non-transmitted VAP of the first MBSSID group. At step 404, if it is determined that the second MBSSID group does not satisfy the VAP steering criterion, the AP, at step 408, may remove/delete the non-transmitted VAP of the first MBSSID group.

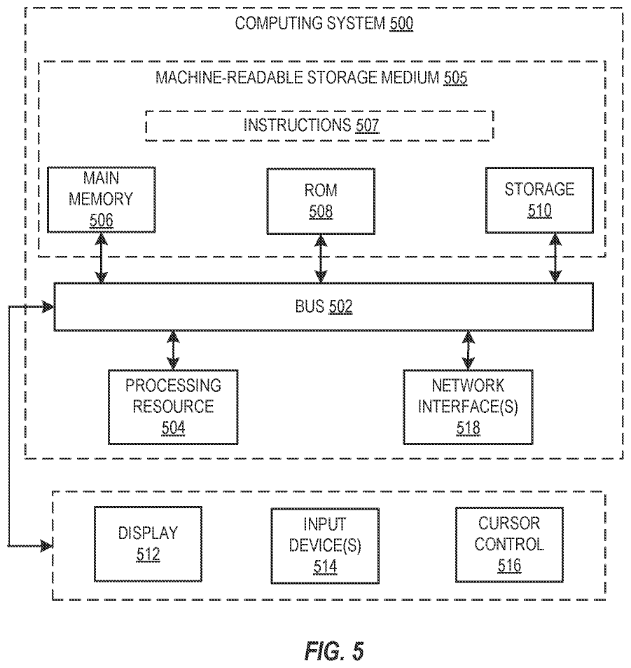

FIG. 5 depicts a block diagram of an example computing system 500 in which various of the examples described herein may be implemented. In some examples, the computing system 500 may be configured to operate as a wireless networking device, for example, an AP can perform various operations described in one or more of the earlier drawings. For instance, the computing system 500 may be an example representative of the AP 100 of FIG. 1.

The computing system 500 may include a bus 502 or other communication mechanisms for communicating information, a hardware processor, also referred to as processing resource 504, and a machine-readable storage medium 505 coupled to the bus 502 for processing information. In some examples, the processing resource 504 may include one or more CPUs, semiconductor-based microprocessors, and/or other hardware devices suitable for retrieval and execution of instructions stored in a machine-readable storage medium 505. The processing resource 504 may fetch, decode, and execute instructions, to configure a plurality of MBSSID groups, in accordance with examples presented herein. As an alternative or in addition to retrieving and executing instructions, the processing resource 504 may include one or more electronic circuits that include electronic components for performing the functionality of one or more instructions, such as an FPGA, an ASIC, or other electronic circuits.

In some examples, the machine-readable storage medium 505 may include a main memory 506, such as a RAM, cache, and/or other dynamic storage devices, coupled to the bus 502 for storing information and instructions to be executed by the processing resource 504. The main memory 506 may also be used for storing temporary variables or other intermediate information during the execution of instructions to be executed by the processing resource 504. Such instructions, when stored in storage media accessible to the processing resource 504, render the computing system 500 into a special-purpose machine that is customized to perform the operations specified in the instructions. The machine-readable storage medium 505 may further include a read-only memory (ROM) 508 or other static storage device coupled to the bus 502 for storing static information and instructions for the processing resource 504. Further, in the machine-readable storage medium 505, a storage device 510, such as a magnetic disk, optical disk, or USB thumb drive (Flash drive), etc., may be provided and coupled to the bus 502 for storing information and instructions.

Further, in some implementations, the computing system 500 may be coupled, via the bus 502, to a display 512, such as a liquid crystal display (LCD) (or touch-sensitive screen), for displaying information to a computer user. In some examples, an input device 514, including alphanumeric and other keys (physical or software generated and displayed on a touch-sensitive screen), may be coupled to the bus 502 for communicating information and command selections to the processing resource 504. Also, in some examples, another type of user input device may be a cursor control 516, such as a mouse, a trackball, or cursor direction keys that may be connected to the bus 502. The cursor control 516 may communicate direction information and command selections to the processing resource 504 for controlling cursor movement on the display 512. In some other examples, the same direction information and command selections as cursor control may be implemented via receiving touches on a touch screen without a cursor.

In some examples, the computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 500 also includes a network interface 518 coupled to bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card or a wireless communication unit (e.g., Wi-Fi chip/module).

In some examples, the machine-readable storage medium 505 (e.g., one or more of the main memory 506, the ROM 508, or the storage device 510) stores instructions 507 which when executed by the processing resource 504 may cause the processing resource 504 to execute one or more of the methods/operations described hereinabove. The instructions 507 may be stored on any of the main memory 506, the ROM 508, or the storage device 510. In some examples, the instructions 507 may be distributed across one or more of the main memory 506, the ROM 508, or the storage device 510. In some examples, when the computing system 500 is configured to operate as an AP, the instructions 507 may include instructions which when executed by the processing resource 504 may cause the processing resource 504 to perform one or more of the methods described in FIGS. 2-4.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method comprising:
configuring, by an access point (AP), a plurality of Multiple Basic Service Set Identifier (MBSSID) groups such that each of the plurality of MBSSID groups is allowed to utilize VAP slots up to a VAP capacity of the AP;
receiving, by the AP, a first request to configure a first VAP in a first MBSSID group of the plurality of MBSSID groups;
responsive to determining that the VAP capacity of the AP is not fully exhausted, creating, by the AP, the first VAP in the first MBSSID group, wherein the first VAP has a first Basic Service Set Identifier (BSSID) that is determined based on a maximum count of VAP slots configurable in each of the plurality of MBSSID groups and a first BSSID index relative to a first transmit VAP of the first MBSSID group;
receiving, by the AP, a second request to configure a second VAP in a second MBSSID group of the plurality of MBSSID groups; and
responsive to determining that the VAP capacity of the AP is not fully exhausted after receiving the second request, creating, by the AP, the second VAP in the second MBSSID group, wherein the second VAP has a second BSSID that is determined based on a maximum count of VAP slots configurable in each of the plurality of MBSSID groups and a second BSSID index relative to a second transmit VAP of the second MBSSID group.

2. The method of claim 1, wherein the maximum count of VAP slots configurable in each of the plurality of MBSSID groups (VAP_{GroupMAXcount}) is determined as 2^{MAXBSSID}^{_{Indicator}}, wherein MAXBSSID_{Indicator} represents a Maximum Basic Service Set Identifier indicator (MaxBSSID indicator).

3. The method of claim 2, wherein configuring the plurality of MBSSID groups comprises setting the MaxBSSID indicator to a value that allows each of the plurality of MBSSID groups to the VAP capacity of the AP.

4. The method of claim 2, wherein configuring the plurality of MBSSID groups comprises setting the MAXBSSID_{Indicator} to
$$\frac{Log ( C )}{Log ( 2 )} ,$$
wherein C represents the VAP capacity of the AP.

5. The method of claim 2, wherein the VAP capacity of the AP is 16, and wherein configuring the plurality of MBSSID groups comprises setting the MaxBSSID indicator to 4.

6. The method of claim 1, wherein determining that the VAP capacity is not fully exhausted comprises ascertaining that a count of configured VAPs on the AP is smaller than the VAP capacity.

7. The method of claim 1, further comprising:
determining, by the AP, that the first transmit VAP is inoperative; and
steering, by the AP, a first non-transmit VAP of the first MBSSID group to a second MBSSID group responsive to the second MBSSID group satisfying a VAP steering criterion.

8. The method of claim 7, wherein the VAP steering criterion comprises:
a second transmit VAP in the second MBSSID group is operative; and
a beacon size for the second MBSSID group is smaller than a threshold value.

9. An access point (AP), comprising:
a machine-readable storage medium storing instructions; and
a processing resource coupled to the machine-readable storage medium and configured to execute one or more of the instructions to:
configure a plurality of Multiple Basic Service Set Identifier (MBSSID) groups such that each of the plurality of MBSSID groups is allowed to utilize VAP slots up to a VAP capacity of the AP;
receive a first request to configure a first VAP in a first MBSSID group of the plurality of MBSSID groups;
responsive to determining that the VAP capacity of the AP is not fully exhausted, create, the first VAP in the first MBSSID group, wherein the first VAP has a first Basic Service Set Identifier (BSSID) that is determined based on a maximum count of VAP slots configurable in each of the plurality of MBSSID groups and a first BSSID index relative to a first transmit VAP of the first MBSSID group;
receive a second request to configure a second VAP in a second MBSSID group of the plurality of MBSSID groups; and
responsive to determining that the VAP capacity is not fully exhausted after receiving the second request, create, in the first MBSSID group, the second VAP in the second MBSSID group, wherein the second VAP has a second BSSID that is determined based on a maximum count of VAP slots configurable in each of the plurality of MBSSID groups and a second BSSID index relative to a second transmit VAP of the second MBSSID group.

10. The AP of claim 9, wherein the maximum count of VAPs in each of the plurality of MBSSID groups (VAP_{GroupMAXcount}) is determined as 2^{MAXBSSID}^{_{Indicator}}, wherein MAXBSSID_{Indicator} represents the Maximum Basic Service Set Identifier (BSSID) indicator (MaxBSSID indicator).

11. The AP of claim 10, wherein the processing resource is configured to execute one or more of the instructions to set the MAXBSSID_{Indicator} to a value that allows each of the plurality of MBSSID groups to utilize the VAP capacity of the AP.

12. The AP of claim 10, wherein the processing resource is configured to execute one or more of the instructions to set the MAXBSSID_{Indicator} to
$$\frac{Log ( C )}{Log ( 2 )} ,$$
wherein C represents the VAP capacity of the AP.

13. The AP of claim 10, wherein the VAP capacity of the AP is 16, and wherein configuring the plurality of MBSSID groups comprises setting the MAXBSSID_{Indicator} to 4.

14. The AP of claim 9, wherein the processing resource is configured to execute one or more of the instructions to ascertain that a count of configured VAPs in the AP is smaller than the VAP capacity.

15. The AP of claim 9, wherein the processing resource is configured to execute one or more of the instructions to:
determine that the first transmit VAP is inoperative; and
steer a first non-transmit VAP of the first MBSSID group to a second MBSSID group responsive to the second MBSSID group satisfying a VAP steering criterion.

16. The AP of claim 15, wherein the VAP steering criterion comprises:
a second transmit VAP in the second MBSSID group is operative; and
a beacon size for the second MBSSID group is smaller than a threshold value.

17. A method comprising:
configuring, by an access point (AP), a plurality of Multiple Basic Service Set Identifier (MBSSID) groups by setting a Maximum Basic Service Set Identifier indicator (MAXBSSID_{Indicator}) to
$$\frac{Log ( C )}{Log ( 2 )} ,$$
wherein C represents a VAP capacity of the AP;
receiving, by the AP, a first request to configure a first VAP in a first MBSSID group of the plurality of MBSSID groups; and
responsive to determining that the VAP capacity is not fully exhausted, creating, by the AP, the first VAP in the first MBSSID group, wherein the first VAP has a first Basic Service Set Identifier (BSSID) that is determined based on the MAXBSSID_{Indicator} and a first BSSID index relative to a first transmit VAP of the first MBSSID group.

18. The method of claim 17, wherein a maximum count of VAPs in each of the plurality of MBSSID groups (VAP_{GroupMAXcount}) is determined as 2^{MAXBSSID}^{_{Indicator}}

19. The method of claim 17, further comprising:
receiving, by the AP, a second request to configure a second VAP in a second MBSSID group of the plurality of MBSSID groups; and
responsive to determining that the VAP capacity is not fully exhausted after receiving the second request, creating, by the AP, the second VAP in the second MBSSID group, wherein the second VAP has a second BSSID that is determined based on the MAXBSSID_{Indicator} and a second BSSID index relative to a second transmit VAP of the second MBSSID group.

20. The method of claim 17, further comprising:
determining that the first transmit VAP is inoperative; and
steering a first non-transmit VAP of the first MBSSID group to a second MBSSID group responsive to the second MBSSID group satisfying a VAP steering criterion, wherein the VAP steering criterion comprises:
a second transmit VAP in the second MBSSID group is operative; and
a beacon size for the second MBSSID group is smaller than a threshold value.
